(19) United States
(12) Patent Application Publication
(10) Pub. No.: US 2005/0034350 A1
(43) Pub. Date: Feb. 17, 2005

(54) Segmented fishing rod with ferrule joining rod sections

(76) Inventor: Charles Foster, Bremerton, WA (US)

Correspondence Address: LAW OFFICE OF DAVID L. TINGEY, 321 BURNETT AVE. S., STE 303, RENTON, WA, 98055, US

(21) Appl. No.: 10/633,195

(22) Filed: Aug. 1, 2003

(51) Int. Cl. A01K 87/00

(52) U.S. Cl. 43/18.1 CT

(57) ABSTRACT

A one-piece tubular ferrule affixed to a first rod section end with a first rod section end fit and bonded into a tubular opening coaxial with the rod section. A wrap such as a thread may also tighten the ferrule around the first rod section end. A second ferrule tubular opening coaxial with the first opening removably receives a second rod section end therein. The second ferrule tubular opening is uniformly lined with a pliant, mildly adhesive liner secured to the opening inner wall. The liner then engages the second rod section end in retaining it in the ferrule until withdrawn under pulling force of removal. The second rod section end typically is prepared with a thread wrap around its circumference to provide a nonsmooth surface that provides an improved engaging surface for the mildly adhesive liner to grasp. Yet, while the liner cooperates with the tubular opening to maintain the second rod section in alignment with the first rod section, it is also conducive to facile removal of the rod section from the ferrule.

### BACKGROUND

1. Field of the Invention

This invention relates to fishing rods, and more particularly to ferrules joining sections of a segmented fishing rod.

2. Prior Art

It is known to have ferrules joining sections of segmented fishing rods; that is, rods typically are made of a plurality of rod sections joined together by ferrules. During nonuse, the rod sections are separated for convenience in storage and transport. Thus, the ferrule facilitates the removable joinder of rod sections.

Ferrules commonly comprise two parts, a first part affixed to a rod first section and a second part affixed to a rod second section, engaging in a matching interface to join the rod first and second sections. Ferrule parts must be carefully aligned as they are bonded to rod section ends so the sections are subsequently aligned when they are connected. Typically, matching male and female parts join in a friction fit, each bonded to a rod section. Friction fit ferrules require close tolerance manufacturing, which close tolerance deteriorates over time and becomes ineffective and is damaged when sand and the like dirty the matching surfaces. The ferrule parts are commonly slipped over the sections ends and bonded. The section ends usually are turned down to make them smooth and fit a ferrule opening in which they are received. This weakens the rod, which becomes a failure point, a point at which the rod will often break. This configuration of one ferrule part mating within the other results in two layers of ferrule material. Even when the ferrule material is flexible, the double layer exacerbates the added stiffness imposed by the ferrule on the rod.

An object of the present invention is to circumvent the need for close tolerance manufacturing of the mating ferrule surfaces. Another is to obviate the need to maintain clear ferrule surfaces. A still further object is to reduce stiffness added to a rod by the ferrule. Another object is to eliminate the need to turn down rod section ends and the consequent failure points it introduces in a rod. Another object is to minimize the need to align the ferrule with both rod sections.

### SUMMARY

These objects are achieved in a one-piece tubular ferrule affixed to a first rod section end with a first rod section end fitting into a tubular opening coaxial with the rod section. Typically, the first rod section is bonded to the ferrule with adhesive. A wrap such as a thread may also tighten the ferrule around the first rod section end.

A second ferrule tubular opening coaxial With the first opening removably receives a second rod section end therein. The second ferrule tubular opening is uniformly lined with a pliant, mildly adhesive liner secured to the opening inner wall. The liner then engages the second rod section end in retaining it in the ferrule until withdrawn under pulling force of removal. The second rod section end typically is prepared with a thread wrap around its circumference to provide a nonsmooth surface that provides an improved engaging surface for the mildly adhesive liner to grasp. Yet, while the liner cooperates with the tubular opening to maintain the second rod section in alignment with the first rod section, it is also conducive to facile removal of the rod section from the ferrule. Sand or other grit is also tolerated, being absorbed into the shape of the threaded second section end as the pliant liner conforms around the section end.

### BRIEF DESCRIPTION OF THE DRAWINGS

FIG. 1 is a side cut-away view of the ferrule of the present invention shown to affixed between a rod first section end and a rod second section inserted into a pliant ferrule liner.

FIG. 2 is a side cut-away view of the ferrule mounted on the rod first section end in alignment with a rod second section end with thread wraps around slits.

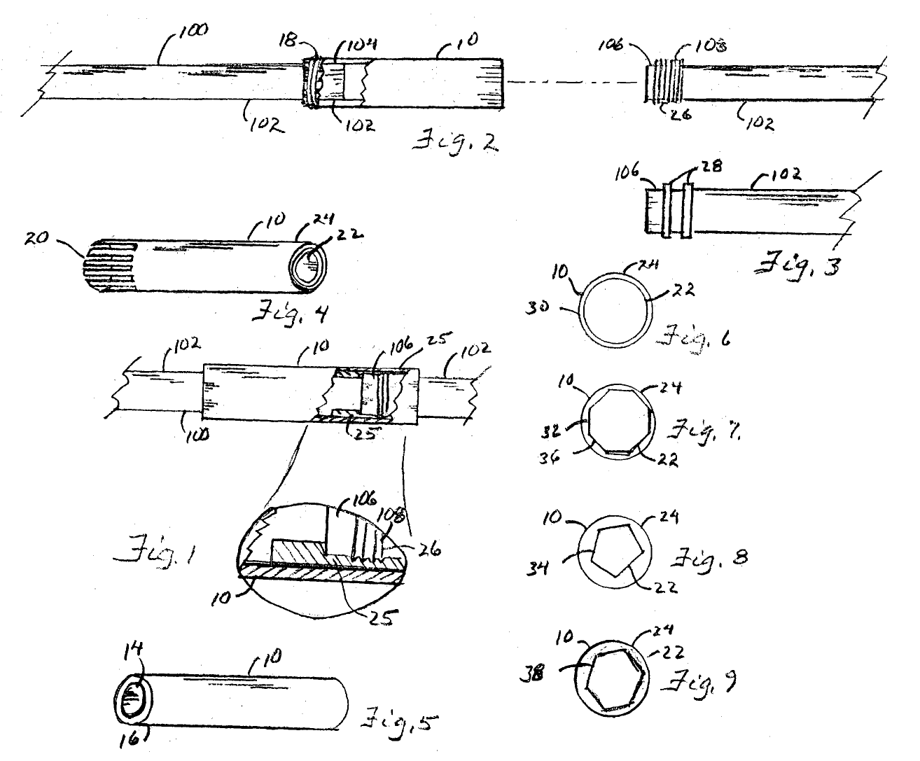

### DETAILED DESCRIPTION OF THE PREFERRED EMBODIMENT

A segmented fishing rod 100 comprises a number of sections 102 joined at first and second section ends 104 and 106. A single-piece ferrule 10 is employed to detachably join fishing rod section ends 104 and 106 with the ferrule affixed to first rod section end 104 coaxially with the first rod section end 104 fitting in the ferrule 10. Typically, the ferrule has tubular body 12 with a first bore or opening 14 in a tubular first end 16 into which the first rod section end 104 is received, bonded therein with adhesive. A thread 18 may wrap around the ferrule tubular first end 16 and tightened to bind it to the rod first section end 104. Ferrule first end 16 may include longitudinal slits 20 around which thread 18 is tightened, urging the first end 16 tightly around the section end 104.

The ferrule body also has a second bore or opening 22 in a tubular second end 24 coaxial with the first bore or opening 14 into which the second rod section end 106 is releasably received in joining ends 104 and 106 of said first and second fishing rod sections 102 in axial alignment. A pliant, mildly adhesive liner 25 is secured inside the tubular body second end 106, releasably engaging the fishing rod second section end 106 received therein. The second section end 106 is configured with a nonsmooth outer surface 108 so the pliant liner 25 resiliently conforms to the nonsmooth surface 108 of the end 106 in grasping the second section end in joining the section ends, but yields under force of removing the second section end in separating the sections. Thus, the fishing rod second section 106 is retained in the tubular body second end 24 against inadvertent or unintentional separation by the pliant, mildly adhesive liner 25 until removed under pulling force of a user.

Typically, the nonsmooth surface 108 comprises a line 26 wrapped in a plurality of wounds around the second section end. A coating may be applied over the wounds for added protection and strength. Alternatively, the nonsmooth surface 108 may comprise at least one annular ridge 28 circumferential around the second section end.

To reduce stiffness in the rod 100, the ferrule body is resiliently flexible with a stiffness approximately equal to the fishing rod sections at their joining ends 104 and 106.

Typically, the cross section of the first and second ferrule openings are circular. In alternative embodiments, the ferrule can be employed to connect rod sections having different cross-sections at their joining ends 104 and 106. This is achieved in the ferrule having first and second openings 14 and 22 of different shapes. Conceivably, tubular opening cross section 30 may comprise a plurality of equal-length lines 32 forming the circumference of the tubular opening, such as in forming a pentagonal opening 34 or an octagonal opening 36 or a hexagonal opening 38.

1. A ferrule for removably connecting first and second sections of a fishing rod, comprising,
a tubular body having openings at tubular first and second ends adapted to receive joining ends of said first and second fishing rod sections, respectively, the tubular body first end affixed to the joining end of said fishing rod first section,
a pliant, mildly adhesive liner secured inside the tubular body second end, adapted to releasably engage the joining end of said fishing rod second section received therein, resiliently conforming to the second section joining end in releasably grasping it within, such that the fishing rod second section is removably retained in the tubular body second end by the pliant, mildly adhesive liner until removed under pulling force of a user.

2. The ferrule of claim 1 wherein the body is resiliently flexible with a stiffness approximately equal to that of the fishing rod sections.

3. The ferrule of claim 1 wherein the ferrule tubular body second end with liner secured therein is adapted to receive and removably engage said joining end of said second section of said fishing rod configured with a nonsmooth outer surface, the liner resiliently conforming to said nonsmooth outer surface in grasping said joining end of said second section in releasably joining the section ends and yielding under force of removing the second section end in separating the sections.

4. A fishing rod including at least first and second sections connecting at first and second section joining ends, the improvement comprising,
a ferrule affixed to the first section joining end received in a ferrule first end and having a tubular opening in the ferrule at a ferrule second end opposite said ferrule first end and said first section joining end therein,
a pliant, mildly adhesive liner secured within the tubular opening adapted to releasably engage the second section joining end upon receiving it therein, resiliently conforming to the second section joining end in releasably grasping it within.

5. The fishing rod of claim 4 wherein the second section joining end further comprises a nonsmooth outer surface, the liner resiliently conforming around the nonsmooth outer surface in releasably clasping it upon insertion of the nonsmooth outer surface into the tubular opening therein impeding unintentional separation of the sections and yielding and releasing it under pulling force as it is removed from the ferrule.

6. The fishing rod of claim 5 wherein the nonsmooth outer surface comprises a line wrapped in a plurality of turns around the second section end.

7. The fishing rod of claim 5 wherein the nonsmooth outer surface comprises at least one annular ridge circumferential around the second section end.

8. The fishing rod of claim 6 further comprising a coating over the turns.

9. (Cancel) The fishing rod of claim 4 wherein the ferrule includes an attachment end with a bore receiving the first section end in axial alignment with the second section received into the ferrule tubular opening.

10. (Cancel) The fishing rod of claim 8 further comprising a nonsmooth surface with adhesive permanently adhering the nonsmooth surface to the ferrule within the ferrule bore.

11. The fishing rod of claim 4 wherein the ferrule adapts a first section to connection to a second section of different cross section wherein the cross section of the tubular opening comprises a plurality of equal-length lines forming the circumference of the tubular opening.

12. The fishing rod of claim 11 wherein the tubular opening is pentagonal.

13. The fishing rod of claim 11 wherein the tubular opening is octagonal.

14. The fishing rod of claim 11 wherein the cross section of the first section is circular.
